(19) United States
(12) Patent Application Publication
(10) Pub. No.: US 2014/0373949 A1
(43) Pub. Date: Dec. 25, 2014

(54) HYDRAULIC COUPLING FOR QUICK COUPLING

(71) Applicant: Fernando MANZATO, Caxias do Sul (BR)

(72) Inventor: Fernando MANZATO, Caxias do Sul (BR)

(21) Appl. No.: 14/312,849

(22) Filed: Jun. 24, 2014

(30) Foreign Application Priority Data
Jun. 25, 2013 (BR) 102013016280.9

(51) Int. Cl. F16L 37/36

(52) U.S. Cl. CPC F16L 37/36
USPC 137/614.04

(57) ABSTRACT

A hydraulic coupling for a quick coupling, whether it is ISO A or ISO B type or flat face, which makes the hydraulic system more compact with a better distribution of the coupling forces, easier machining operation, and a coupling system between the couplings under a more efficient pressure. A first purpose of the invention is the improvement in hydraulic coupling for a quick coupling, which has a greater contact surface, employs a smaller diameter for the plug coupling connector in the socket coupling, allowing a greater amount of balls without reducing the material section between the holes that host the balls, and giving the same resistance to the connector as well as a greater support area due to the greater number of balls. Secondly, it is an improvement of the present invention a hydraulic coupling for a quick coupling, which adopts an asymmetrical geometry of the plug coupling peripheral duct that allows applying a more practical and economic tool. The plug coupling duct geometry enables machining with a cutting tool with support of 93° exit angle of approximately 27°, which makes possible to use triangular inserts. The third purpose of the present invention is an improvement in hydraulic coupling for a face-flat type quick coupling, which adopts only one internal in both plug and socket couplings. In the proposed coupling there is no isolated area of the pressurized hydraulic system, however, it is possible to move the because it has an area equalization system, which enables the displacement with a likely force for a human operation. That called equalizer for the plug coupling, and called equalized for the socket coupling has a similar axial hydraulic strength that propagates in both directions forwards and backwards. Thus, from such compensation, it is possible to move it during the coupling operation in the socket, even if its line is under full working pressure.

### CROSS-REFERENCE TO RELATED APPLICATIONS

The present application claims benefit of Brazilian Application no. 10 2013 016280 9, filed Jun. 25, 2013, the contents of which are incorporated herein by reference.

### TECHNICAL FIELD OF THE INVENTION

The present invention refers to the improvement in hydraulic coupling for quick coupling, whether it is ISO A or ISO B type or flat face, which makes the system more compact with a better distribution of the coupling forces and with easier machining operation and coupling system between the couplings under a more efficient pressure.

### BACKGROUND OF THE INVENTION

In the hydraulic systems, the power is transmitted and controlled through a liquid under pressure in a closed circuit. The quick couplings are used to switch on and off the fluid conduction line without using special tools or devices.

ISO 7241-1 standard covers the geometry and interface dimensions, and specific requirements of basic performance for the A and B series quick couplings for general purposes.

ISO 16028 standard covers the geometry and interface dimensions, and specific requirements of basic performance for quick hydraulic couplings known as flat face and intended to minimize oil leakage by decoupling, and minimize air insertion by coupling.

Generally, conventional quick socket couplings are intended to couple the plug couplings (pins) that are assembled in the hose ends or the tool disconnection points or implements. Conventional coupling models are presented in the FIGS. 1 and 2 (ISO 7241-1 standard coupling), and in the FIGS. 3 and 4 (ISO 16028 standard coupling) a face-flat standard conventional set (plug and socket) is illustrated.

So, in the FIG. 1 from (1) to (11) we present the socket coupling components, and from (12) to (17) the plug coupling components.

The socket includes a connecting body (1) with a number of conventional balls (9) that follow the height of the ISO 7241-1 standard (FIG. 9), which is fixed by a glove (7), allowing the ball release upon the spring shrinkage (6) that has a buffer (5) at the time the plug coupling couples the socket coupling, FIG. 2. Inside both parts we find a check valve (4) (15) that has the tightness function at the time the plug body (12) and the socket connecting body (1) are separate (FIG. 1), whereas when coupled (FIG. 2), this valve allows free fluid flow between the parts.

This tightness valve (4) (15) present in those two bodies consists of a sealed pin guided by a guide (3) (17) fixed by an elastic ring (02) (14), being a buffer for the spring (11) (16) that moves the sealed pin (4) (15) from the retaining position to the free fluid flow.

When the parts are connected, the o'ring (10) sealing is responsible for the system tightness. In the plug we can identify, in addition to the ball dimensioned by the height of the ISO 7241-1 standard, the 45° duct exit angle (13).

In the FIG. 3 we have another set model that follows the ISO 16028 standard. In this product we also have the same previous application, however the conventional constructive model differs.

Therefore, we have from item (18) to (29) components that form the socket coupling that do not have a function to couple under internal pressure. In its turn, from (30) to (45), we have the plug coupling items that, through a series of valves, enables the coupling under pressure. Thus, the socket consists of a vented threaded body (18) that fixes the pin through a thread and sealing (19) that, when uncoupled from the plug coupling, has the function of tightness together with the 2^{nd} valve (28) and the o'ring (25) that also works when the parts are coupled (FIG. 4), the threaded and sealed pin (19) is also used when the parts are connected (FIG. 4). It pushes the non-equalized valve (31) from the plug coupling, which shrinks together with the springs (34) and (36) of the plug part, and the springs (26) and (27) of the socket part, thus releasing the fluid flow between the parts as we can see in the FIG. 4.

The 1^{st} valve (29) has the function of protecting against dirtiness that can go into the socket coupling, and has a final buffer in the connector (20) that shrinks the conventional balls (23) that follow the height of the ISO 16028 standard (FIG. 10), and serve as a lock for the default plug pin (32) when coupled (FIG. 4). It is the glove (21) surrounding the connector (20) that locks the balls in the plug coupling duct (45), the connector spring (22) assumes responsibility for the glove axial movement (21) at the moment of the coupling, whereas the elastic ring (24) puts it at the locking position, so if that ring leaves the connector duct position (20), an accident may occur, making the parts (plug and socket) to involuntarily uncouple from the default plug coupling pin (32).

In the plug coupling we have three valves (31) (33) (37) that enable the coupling of the plug part under internal pressure, normal working pressure. The conventional plug capable of coupling under pressure is characterized by a number of valves that separate the pressurized part (44) from the non-pressurized one (41). This model consists of a 1^{st} valve (31) tight by a sealing (30) concerning the non-pressurized environment (41), which has the function of tightness in the plug coupling; the 1^{st} valve positioning is given through the spring (34). The 2^{nd} valve (33) separates the pressurized region (44) from the non-pressurized one (41), and through a relatively small area, this valve (33) can be moved even with the pressurized system. It separates the areas (41) and (44) as an aid for the sealing (42) and (43).

The 3^{rd} valve (37) is responsible for allowing the fluid output from the non-pressurized region (41) because if there was no valve, the non-pressurized area (41) could generate pressure in the fluid at the moment of the coupling, not allowing the coupling movement.

The 3^{rd} valve (37) has a spring (38) and a guide (39) the same way as the other valves.

Next, we will go further by showing the limitations of this current state of the art in the range of quick couplings, which follows the ISO 7241-1 and ISO 16028 standards.

### Limitations of the State of the Art Regarding the Contact Surface of the Balls in the Plug Coupling Groove

According to the ISO 7241 and ISO 16028 standards, the amount of balls (9) (23) existing in the connector (1) (20) is limited based on the ball diameter (Ø L), the ball collar diameter (Ø A), and the ball spacing (see FIGS. 9 and 10 of the present patent application, which are reproductions of the FIGS. 1 and 3 of the referred standards).

The table values below were taken from the Tables 1 and 2 of the ISO 7241-1 standard, which defines the parameters for the coupling projects:

Table 1 of the ISO 7241-1 standard (Series A)

| Size | Ø A | H | Ø L |
|---|---|---|---|
| 6.3 | 18.7 | 6.6-6.8 | 3.968 |
| 10 | 24.1 | 9.9-10 | 3.968 |
| 12.5 | 30.3 | 11.6-11.8 | 4.762 |
| 20 | 37.1 | 17.5-17.7 | 4.762 |
| 25 | 43.0 | 22.8-23 | 4.762 |
| 31.5 | 56.0 | 28.4-28.6 | 6 |
| 40 | 68.5 | 33.7-33.9 | 8 |
| 50 | 83.7 | 39.6-39.8 | 10 |

Table 2 of the ISO 7241-1 standard (Series B)

| Tamanho | Ø A | H | Ø L |
|---|---|---|---|
| 5 | 16.69 | 11.25-11.48 | 3.175 |
| 6.3 | 21.21 | 13.41-13.61 | 3.967 |
| 10 | 26.87 | 15.52-15.72 | 4.763 |
| 12.5 | 33.45 | 17.17-17.37 | 5.555 |
| 20 | 41.66 | 23.86-23.06 | 5.555 |
| 25 | 49.38 | 27.36-27.56 | 6.35 |

The table values below were taken from the Table 1 of the ISO 16028 standard, which defines the parameters for the face-flat type couplings:

Table 1 of the ISO 16028 standard

| Tamanho | Ø A | H | Ø L |
|---|---|---|---|
| 6.3 | 20.50 | 5.70-5.80 | 3.175 |
| 10 | 24.1 | 4.68-4.86 | 3.175 |
| 12.5 | 30.15 | 9.75-9.95 | 3.969 |
| 16 | 32.65 | 9.75-9.95 | 3.969 |
| 19 | 36.68 | 11.30-11.50 | 4.762 |
| 25 | 44.85 | 10.80-11.00 | 6.350 |

Still according to the ISO standards, the H value, that measures the distance from the beginning of the ball to the plug coupling face, aims to, in conjunction with the specified quota Ø A and Ø L, ensure the distance from the beginning of the groove where the socket coupling connector balls position themselves in relation to the plug coupling face.

A first limitation of the state of the art is that all manufacturers design their socket couplings with a ball diameter according to the Ø L value of the ISO standards, which limits the amount of balls that can be used. This is due to the fact that if the amount of holes (46) (48) is increased dramatically, there is little material left in the connector wall (1) (20) (component that houses the balls), weakening and causing the risk of breaking the connector wall (47) (49), please see FIG. 11.

As a direct consequence of such limitation, the socket couplings have an external diameter greater than the necessary to obtain the same internal section of fluid flow, please see FIG. 14 (ISO 7241-1 series couplings), 10 and 15 (ISO 16028 series couplings).

A second limitation refers to the number of contact points of the balls (9) (23) in the plug coupling groove (13) (45), please see FIGS. 1 and 3. Following the usual diameter standard of the balls, the different coupling sizes have a maximum number of applicable balls in the project, otherwise the connector walls (47) (49) can be weakened in case the number of balls is exceeded. Thus, the project determines a certain maximum number of points contacting the plug coupling groove (13) (45) when the couplings are connected (FIGS. 2 and 4).

Unfortunately, such limitation reduces the product life cycle because the plug groove (13) (45) is responsible to maintain the plug and socket parts connected, even if the internal fluid is pressurized, that extreme pressure dissipates a considerable power in the plug coupling groove, and the fewer balls (9) (23), the fewer stress relieving points cause premature wearing in the plug coupling groove (13) (45), even in the balls (9) (23), many times about to prevent the operation of the item.

### Limitations Regarding the Plug Coupling Groove Manufacturing Method

A characteristic of the plug pin that follows the ISO 7241-1 standard is that the plug part groove (13) in the geometry that has no contact with the balls is usually found in two concepts with a 45° exit angle (83) or in radius (100), please see FIG. 12. Such conventional geometry of the plug coupling peripheral duct limits the coupling machining in only three profiles of cutting tools:
Form insert (tailored tool with only one cutting edge);
Losangular insert (diamond-shaped tool with two or four cutting edges);
Radius tool (tool with a radius-shaped cutting edge with one or two cutting edges).

The conventional geometry of the plug coupling peripheral duct does not allow performance of the machining operation with a usual 93° triangular inserts supported type cutting tool.

### Limitations of the State of the Art Regarding the Coupling Under Pressure of the Face-Flat Coupling Plug Part

In order to occur the coupling under pressure (working pressure) of the plug part of the face-flat couplings, the conventional quick couplings (please see FIG. 13 of the ISO 16028 standard) use more than one internal valve (31) (33) (37) and adopt the conception of separation chambers (41) (44), which enables that the 1^{st} coupling valve (31) is isolated from the pressurized hydraulic system (44) when it is found uncoupled from the socket part. Thus, the valve only connects to the system by opening the way to the fluid when it is completely coupled. Such system allows the coupling because it has a 2^{nd} valve (33) with a small area that needs a despicable power to move the 2^{nd} valve (33), opening the way to the hydraulic oil.

### Limitations of the State of the Art Regarding the Coupling Under Pressure of the Face-Flat Coupling Socket Part

The conventional face-flat socket couplings do not have the coupling function under working pressure. The only models that allow such an accomplishment have an additional that have the same functional principle as the plug models that couple under pressure (FIG. 13). Thus, the market models shown in FIG. 22 have limitation on the question coupling under pressure.

### SUMMARY OF THE INVENTION

The first purpose of the present invention is an improvement developed in hydraulic coupling for a greater contact area that employs a smaller diameter in the plug coupling connector balls to the socket coupling, allowing to adopt a greater amount of balls without reducing the material section between the holes that host the balls, giving the same resistance to the connector and a greater support area due to a greater number of balls.

As a result, the coupling of the invention enables a greater mechanical strength dissipation applied in the plug coupling peripheral groove.

Thus, a greater life cycle is obtained for the plug coupling because its peripheral groove relies on a greater number of balls, distributing the axial strength which propagates when the couplings are connected and the system is pressurized. Secondly, it is an improvement of the present invention a hydraulic coupling for a quick coupling, which adopts an asymmetrical geometry of the plug coupling peripheral duct that allows applying a more practical and economic tool.

The innovative geometry of the plug coupling duct enables the machining with a cutting tool with a 93° exit angle support of approximately 27°, which allows using triangular inserts (triangle-shaped tools with three or six cutting edges). The third purpose of the present invention is an improvement in hydraulic coupling for a face-flat type quick coupling, which adopts only one internal in both plug and socket couplings. In the proposed coupling there is no isolated area of the pressurized hydraulic system, however, it is possible to move the because it has an area equalization system, which enables the displacement with a likely strength for a human operation. That called equalizer for the plug coupling, and called equalized for the socket coupling has a similar axial hydraulic strength that propagates in both directions forwards and backwards. Thus, from such compensation, it is possible to move it during the coupling operation in the socket, even if its line is under full working pressure.

### BRIEF DESCRIPTION OF THE DRAWINGS

The improvement in hydraulic coupling for a quick coupling of the present invention can be better understood through the following detailed description, which is performed based on the following drawings attached listed below:

FIG. 1—axial section from the state of the art of the socket and plug quick couplings, which follow the ISO 7241-1 standard with the uncoupled parts one from another;

FIG. 2—axial section of the socket and plug quick couplings, which follow the ISO 7241-1 standard with the coupled parts one from another;

FIG. 3—axial section from the state of the art of the socket and plug quick couplings, which follow the ISO 16028 standard with the uncoupled parts one from another;

FIG. 4—axial section from the state of the art of the socket and plug quick couplings, which follow the ISO 16028 standard with the coupled parts one from another;

FIG. 5—axial section of the socket and plug quick couplings, which follow the ISO 7241-1 standard with the uncoupled parts one from another, as proposed by the invention;

FIG. 6—axial section of the socket and plug quick couplings, which follow the ISO 7241-1 standard with the coupled parts one from another, as proposed by the invention;

FIG. 7—axial section of the socket and plug quick couplings, which follow the ISO 16028 standard with the uncoupled parts one from another, as proposed by the invention;

FIG. 8—axial section of the socket and plug quick couplings, which follow the ISO 16028 standard with the coupled parts one from another, as proposed by the invention;

FIG. 9—partial side view of the quick plug coupling of the ISO 7241-1 standard;

FIG. 10—partial side view of the quick plug coupling of the ISO 16028 standard;

FIG. 11—isometric view of the connectors, socket coupling connector on the left that follows the ISO 7241-1 standard, and the one that follows ISO 16028 standard on the right;

FIG. 12—side view of the quick plug coupling of the ISO 7241-1 standard, showing two usual manufacture geometries of the plug coupling groove;

FIG. 13—axial section of two plug quick couplings that follow the ISO 16028 standard, and have more than one to perform the coupling under working pressure;

FIG. 14—front view of the socket coupling of the ISO 7241-1 standard, showing the difference between the balls of the conventional model (state of the art) on the left, and the ones of the invention model on the right;

FIG. 15—front view of the socket coupling of the ISO 16028 standard, showing the difference between the balls of the conventional model (state of the art) on the left, and the ones of the invention model on the right;

FIG. 16—partial side view of the quick plug coupling of the ISO 7241-1 standard with the 27° exit groove, as proposed by the invention;

FIG. 17—axial section of the face-flat plug and socket coupling of the ISO 16028, as proposed by the invention;

FIG. 18—axial section of the face-flat plug coupling (ISO 16028) proposed by the invention, showing the equalizer containing the dimensioning model;

FIG. 19—side view of the face-flat coupling proposed by the invention, showing the disassembled components;

FIG. 20—axial section of the face-flat socket coupling of the ISO 16028 standard proposed by the invention with equalized, and its mathematical attribution;

FIG. 21—side view of the equalized;

FIG. 22—axial section of two conventional quick socket couplings, which follow the ISO 16028 standard, and do not have coupling function under working pressure;

FIG. 23—axial section of the face-flat socket coupling of the ISO 16028 standard proposed by the invention, showing in detail the buffer duct for the glove spring;

FIG. 24—schematic views of the “spiralock” thread.

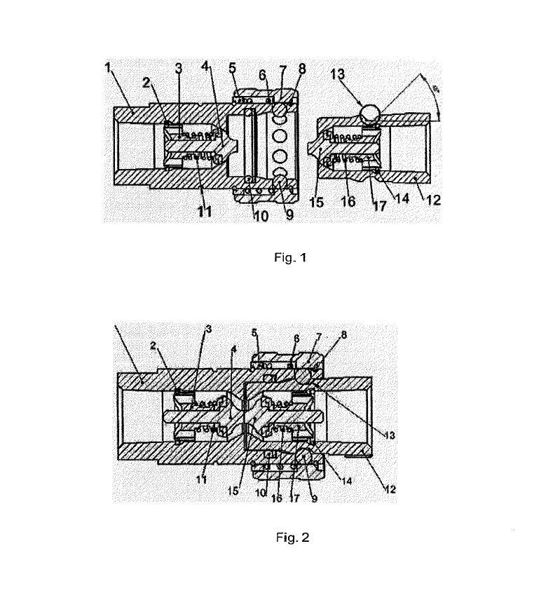

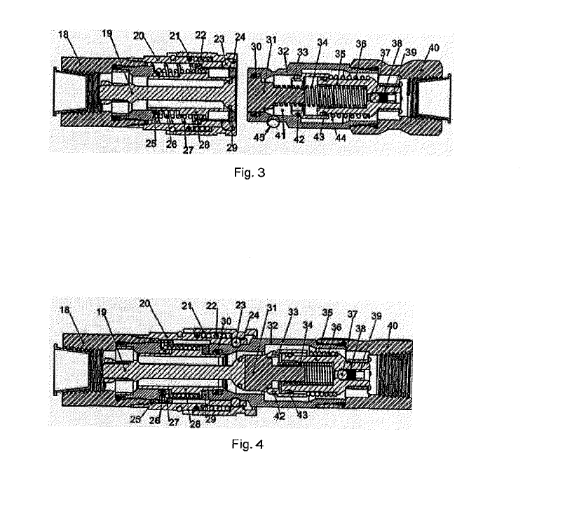

### DESCRIPTION OF PREFERRED EMBODIMENTS

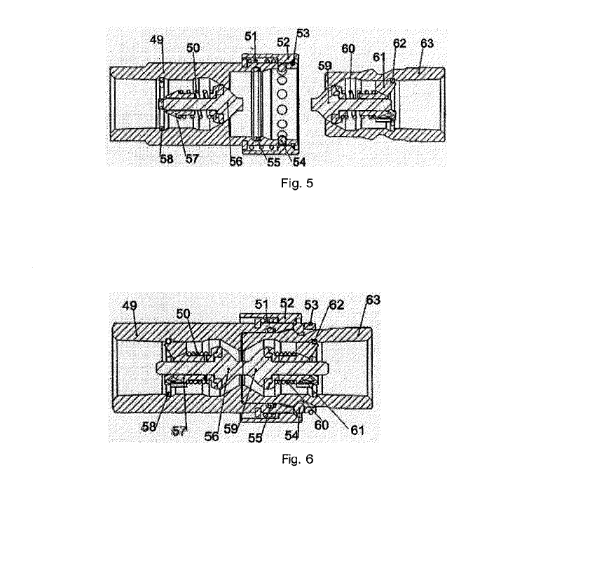

The FIGS. 5, 6, 7 and 8 illustrate the socket and plug hydraulic couplings for quick coupling recommended by ISO 7241-1 and ISO 16028 standards, which present the characteristics of the invention.

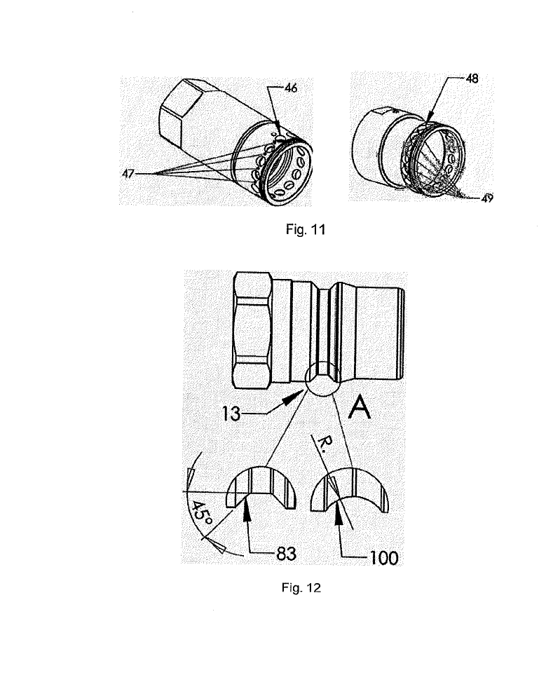

The FIGS. 5 and 6 detail the hydraulic coupling of the invention, which presents a greater contact surface, thanks to the proposed dimension of the balls (54) (68) of the connector that sticks to the plug coupling groove (85), which allows using a greater number of balls (54) (68) in the connector (49) (65), without reducing the material section (47) (49) between the holes (46) (48) that hosts the balls (54) (68), giving the necessary resistance for the connector (49) (65), and allowing a greater number of lodgings (46) (48) for the balls, having more balls (54) (68), please see detailing of the FIG. 11.

With a greater number of balls in the connector (49) (65), we reduce stress between the balls (54) (68) in the plug coupling groove (85) because the load is dissipated. In some cases, the plug coupling groove deforms by the stress used, raising the wall at 45° of the plug coupling groove (85). Such deformation is smaller if the number of contact points is greater. Through the balls with a smaller diameter, we enable the coupling to install a greater number of balls, which, consequently, enable a dissipation of the hydraulic form, ensuring a greater life cycle for the plug coupling, and reducing the plug coupling groove deformation, all of this due to the research that gives the coupling a ball different from proposed in order to measure the H dimension of the ISO 7241-1 and ISO 16028 standards.

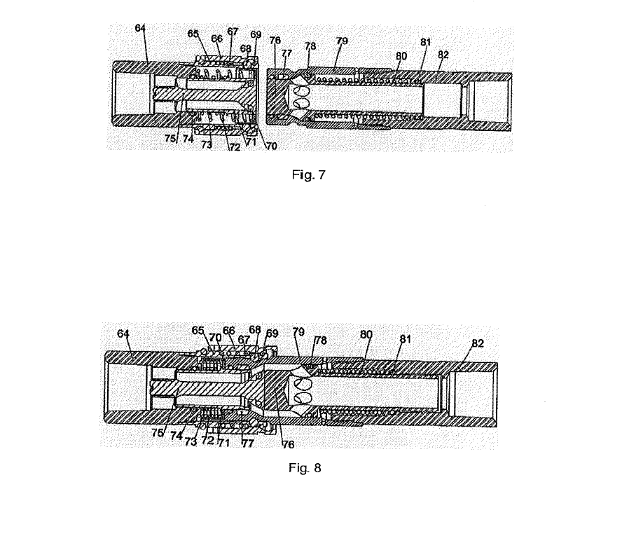

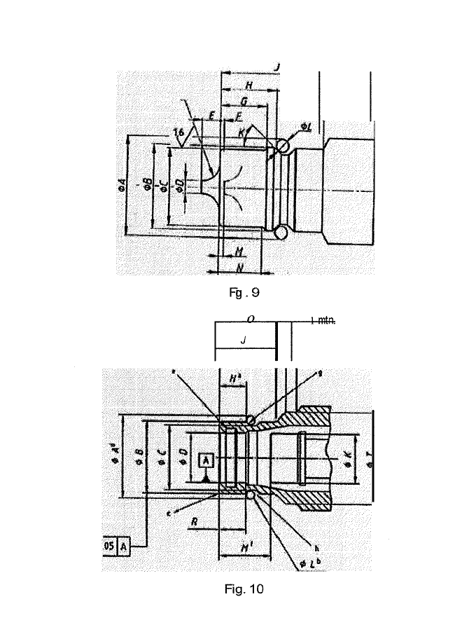

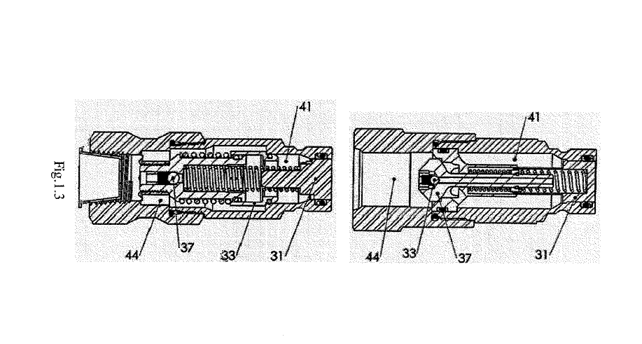

The FIGS. 7 and 8 detail the hydraulic coupling for a face-flat quick coupling, which employs only one internal (76) (71) in both the plug and socket couplings. In the proposed coupling, there is no isolated area of the pressurized hydraulic system (41), much less an additional relief (33), as can be seen in the conventional models of the FIG. 13. However, it is possible to move the (76) (71) without a relief because it has an area equalization system, which enables the displacement with a likely strength for a human operation. Such s called equalizer (76) for the plug coupling, and equalized (71) for the socket coupling have a similar axial hydraulic strength that propagates in both directions, whereas an area of the, which is in contact with the pressurized fluid, pushes it in one direction, while other region, which is also in contact with the fluid, pushes it in the opposite direction. This phenomenon happens because the s were designed to cancel forces when pressurized inside the system. Thus, from such compensation, it is possible to move the s during the coupling operation, even if the line is under full working pressure because the only necessary strength to be overcome is the spring forces (80) (73) (72), once the fluid under pressure is not an obstacle to the coupling.

The coupling body (64) has a central pierced wall where the central pin (75) is inserted, fixed by a thread (86), which has a prominent and flat head, hence the name “flat face”.

The equalized (71) slides inside the coupling body (64), being sealed by an o'ring (74). The (71) is kept against the central pin head (75) by a spring (73), which is between the coupling body (64) and an external ring (99). A second spring (72) is assembled around the first spring (73) and is supported on the coupling body (64), and keeps the protection (70) sealed against an existing peripheral internal prominence on the anterior connector face (65) in order to isolate the equalized (71) from the external environment.

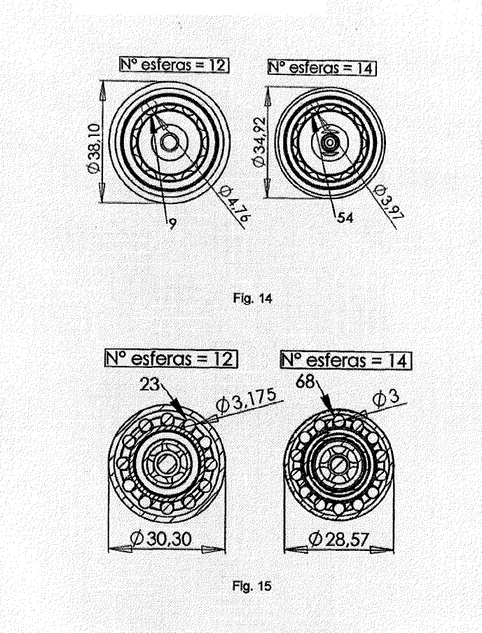

Based on the FIG. 14, we have an example where it is possible to verify that with the balls (L) shown in the ISO 7241-1 standard of Ø 4.76 mm (Ø 3/16″), which should only serve to measure the height of the 12.5 sized plug coupling duct, it is possible to assemble a maximum of 12 balls. Diversely, on the size of the quick coupling of the invention corresponding to the ISO standard, it is possible to put 14 balls (L′) of Ø 3.97 mm (Ø 5/32″) without reducing the amount of material resulting on the connector wall (47). Please note that the coupling diameter of the invention (Ø 34.92 mm) decreases in relation to the ISO 7241-1 standard (Ø 38.10 mm), which enables the coupling to be assembled in narrow systems without using spacers.

The table below presents a diameter comparison between the balls mentioned in the ISO 7241-1 standard and the ones used by the invention.

| SIZE | STANDARD SERIES | Ø ISO STANDARD | Ø INVENTION |
|---|---|---|---|
| 6.3 | A | 3.97 | 3.00 |
| 10 | A | 3.97 | 3.00 |
| 12.5 | A | 4.76 | 3.97 |
| 20 | A | 4.76 | 4.50 |
| 25 | A | 4.76 | 4.50 |
| 31.5 | A | 6.00 | 4.76 |
| 5 | B | 3.17 | 2.50 |
| 6.3 | B | 3.97 | 2.50 |
| 10 | B | 4.76 | 3.97 |
| 12.5 | B | 5.55 | 3.50 |
| 20 | B | 6.35 | 4.76 |
| 25 | B | 6.35 | 5.55 |

As you can note in the FIG. 15, the balls (L) shown in the ISO 16028 standard that address the face-flat type quick coupling hydraulic couplings have Ø 3.17 mm (Ø ⅛″), which should serve only to measure the height of the plug duct, and it enables to assemble only 12 balls at maximum. Diversely, on the size of the quick coupling of the invention corresponding to the ISO standard, it is possible to put 14 balls of Ø 3.00 mm (Ø 5/32″) without reducing the amount of material resulting on the connector wall (49).

Please note that the face-flat quick coupling diameter of the invention (Ø 28.57″) also decreases in relation to the ISO 16028 standard, which allows that the coupling is assembled in a more narrow place than its predecessors.

The table below presents a diameter comparison between the balls mentioned in the ISO 16028 standard and the ones used by the invention from the face-flat couplings.

| SIZE | STANDARD BALL Ø | INVENTION BALL Ø |
|---|---|---|
| 6.3 | 3.17 | 3.00 |
| 10 | 3.17 | 3.00 |
| 12.5 | 3.96 | 3.50 |
| 16 | 3.96 | 3.50 |
| 19 | 4.76 | 3.96 |
| 25 | 6.35 | 3.96 |

The FIG. 16 illustrates the plug coupling peripheral duct geometry (85) for supporting the socket coupling connector balls that is asymmetrical and consists of an inclined wall (84) with an angle of approximately 27°, a short horizontal flat wall, and an opposite inclined wall that serves as a support for the balls. Also, in that region the balls are interlocked due to the high stresses requested.

Thus, the invention proposes a plug coupling duct geometry (85) that allows machining with a 93° support cutting tool, which supports triangular inserts (triangle-shaped tools with three or six cutting edges), and give the part a geometry in the exit angles of approximately 27° (84).

Through the cutting tool exit angle of approximately 27°, the pin can be manufactured with no application restriction. Hence, the plug couplings can be machined with a tool with a greater amount of cutting edges.

Please note that it is not only the duct exit (85) to have an angle less than 27°, but there are two more areas that need to follow the same limit. However, such geometry does not impair the plug coupling functioning. Thus, such geometry allows using the 93° supporting tool where once it did not allow manufacturing them. This allows a higher lifetime of the cutting tool that in addition to having a larger number of sharp edges also ensures the tool a geometry more resilient to the depth of the cut in relation to the ones normally used in the manufacturing process. In addition, there is the possibility of eliminating the use of a finishing tool because the triangular geometry tool is generally used in a buffing material, followed by a finishing geometry. With the new procedure, the buffing tool is also responsible for the finishing because the plug coupling geometry is no more a limit.

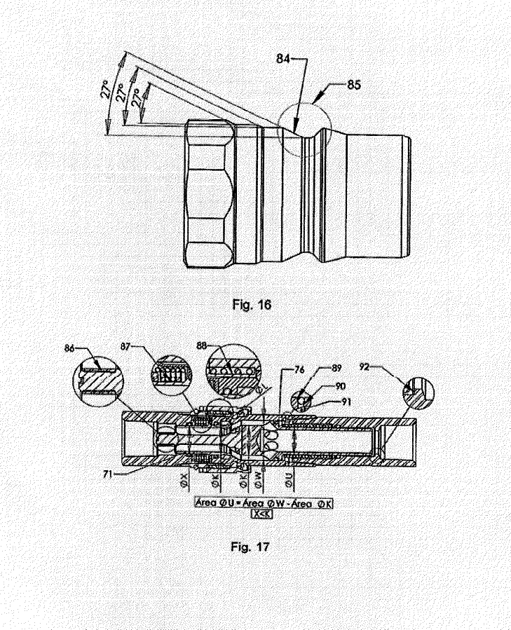

The FIG. 17 illustrates the coupled face-flat hydraulic quick couplings, that is, with the plug coupling introduced into the socket. The characteristic of such couplings is that each one has only one internal (71) (76), and both are able to couple under pressure; they also have both mathematical characteristics that help in the dimensioning, being the first box regarding the equalizer (76) of the plug coupling, and the second one regarding the equalized (71) of the socket.

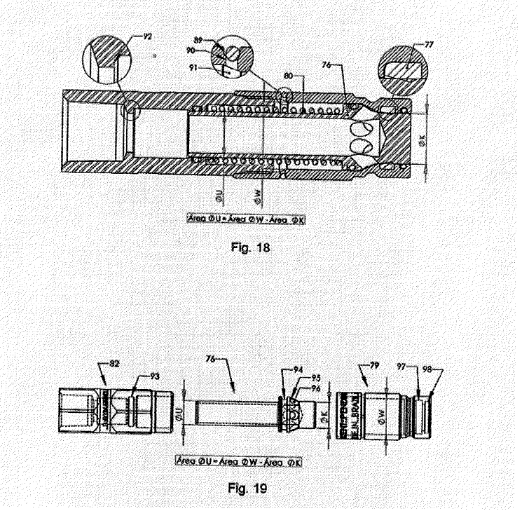

The FIGS. 18 and 19 detail the face-flat plug quick coupling, which has an equalizer internal (76) equipped with an area equalization system that enables the displacement with a relatively low strength. The equalizer (76) has a similar axial hydraulic strength that propagates in both directions, forwards and backwards. Thus, from such compensation, it is possible to move the (76) to implement the coupling operation in the socket coupling, even being under full working pressure.

This equalizer can be dimensioned following the principle of equality of areas where the respective area of the ØU must be similar to the ØW area less the ØK area. Such condition allows developing the couplings of the ISO 16028 with different sizes. As the ØK is defined by the standard through ISO, we can use the other two variables (ØU and ØW) to develop the plug couplings of the invention. Although the equalized is the secret of coupling functioning, two foundations are necessary for the proper system functioning.

The buffer (92) serves to give a stopping place to the at the moment of the coupling under pressure. This is due to fact that, by the time of the coupling, the equalization gets lost because in the ØK region, there is no more than one sealing point (77) with the standard plug pin (79). Hence, the strength goes from equalized to axial in the opposite direction of the coupling, which takes the (76) into the coupling with a significative strength. That movement is interrupted by the buffer (92), and if there was no buffer, the movement strength would be propagated in the spring (80), and could damage it.

The breather (90) is also needed for the system because in the spring chamber (80), when the plug coupling is coupled into the socket coupling, the chamber volume (91) decreases, and the air in the spring chamber can get compact and prevent the coupling to occur because the equalizer (76) does not move due to the air pressure. The problem is solved with a system where the air can freely enter and exit from that chamber (91). The breather (90) is exactly this, an environment, generally a hole, which helps the air input and output from the spring chamber; an o'ring (89) sealing can be applied to avoid dirtiness, and works as a filter.

The plug coupling comprehends an anterior cylindrical part (79), also called coupling pin, which is threaded in a posterior cylindrical part (82), also called coupling body. The equalizer (76) comprehends a ØU cylindrical body, a closed head (95) where a sealing (78) is hosted, before the ØK head. The flap has holes (96) for external oil throughput into the interior (76) or vice versa. The coupling pin (79) has an peripheral internal groove (98) to position a sealing O-ring against the ØK head followed by a second peripheral internal groove (97) for a special sealing that also seals against the ØK head

The coupling body (82) has a peripheral groove (93) for a ØU sealing O-ring mounting. In one chamber (91) located between the equalizer body (76) and the coupling body (82) is placed a spring (80). The coupling body (82) has an internal buffer (92), so there is a stopping place at the moment the coupling under pressure occurs. This is necessary to couple the couplings.

The standard coupling pin (79) has a peripheral external groove (89) with a breather hole (90) for the air outlet when the coupling is being coupled. This is needed because in the spring chamber (91), when it couples the couplings, the area volume decreases, and the air inside the spring chamber (91) can pressurize itself and disrupt the coupling, because the equalizer (76) does not move due to a counter-pressure.

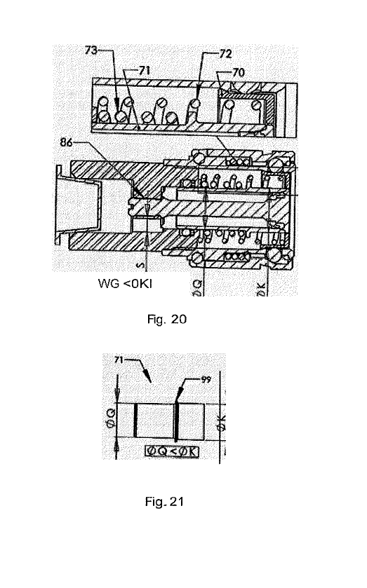

The FIGS. 20 and 21 detail the face-flat socket quick coupling that has one equalized internal (71), and a protection against dirtiness (70). The socket coupling includes an anterior cylindrical part (65) surrounded by balls (68), also known as connector type, which is threaded in a posterial cylindrical part (64), also known as body type, surrounded by a collar or glove (66), plus a face-flat central pin (75).

The invention lays down the socket coupling, where ØQ is less than ØK within a certain range of difference between both dimensions. The equalized (71) presents two peculiar characteristics, that is, there is a specific point where ØQ enables the part coupling under pressure, and does not enable that the opens, leaking oil in the environment. Thus, if we decrease the ØQ, the is becoming less sealed, however it couples with increasingly residual pressure. The invention is different due to the fact that the equalizer (71) has ØQ<ØK.

The springs (72) (73) are concentric and press the equalizer s (71) and the protection s (70), acting independently. So, there is no force opposite to the spring (73) of the equalization (71), which allows the coupling to be smoother. The spring (73) of the equalized (71) is placed inside the spring (72) of the protection (70), allowing an intelligent arrangement, and that uses an inefficient space, reducing the coupling length and making the distance traveled by the oil inside the coupling to be smaller. This helps to reduce load loss inside the. Such spring arrangement one inside the other (87), both inside the protection (70) is thanks to the equalized (71), which has the ØQ less than ØK that creates space for the concentric assembly of the two springs (72) (73).

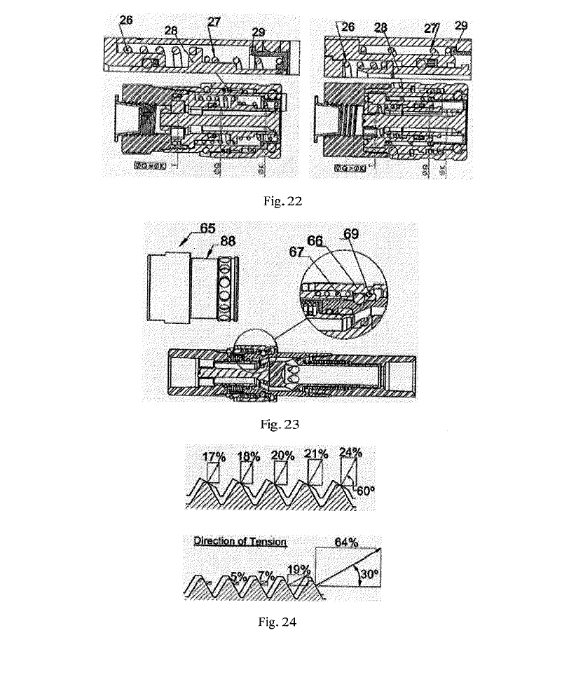

In the FIG. 22, we have examples of couplings that do not have the characteristics of the invention and they are the couplings usually found on the market. Hence, such models do not follow the patent specification, which lays down ØQ<ØK, being the (28) not equalized, so it does not have coupling function under working pressure. The springs (26) (27) also present a different arrangement from the patent in question, and none of the models has both characteristics of being inside one each other and both inside the protection (29).

In the FIG. 23, the connector (65) of the socket coupling has a rabbet (88) that hosts the spring (67). Such rabbet ensures that in case the elastic ring (69) leaves the housing, the glove (66) does not escape the coupling, causing an accident, whereas the glove (66) can be disassembled during the operation and cause an involuntary plug uncoupling, and seriously injure the operator. The spring duct (88) ensures the spring (67) has no possibility to disassemble the glove (66) in case the elastic ring (69) becomes detached from its housing.

The FIG. 24 illustrates a spiralock thread that was used for direct fixing of the pin (75) on the pierced wall (86) of the coupling body (64). The spiralock system is different from the conventional threads because it distributes more homogenously the load in its fillets. While the conventional system distributes a good part of the load in the first fillet, in the figure being discussed, we can see the percentage contrast of the load dissipated in the fillets, showing in the upper part the spiralock system dispersion, and the conventional system below. In the socket quick coupling, such fixation mode offers a number of improvements. The thread does not need to have a nut, glue or being beaded in the last fillet to be properly fixed to the socket coupling because the best distribution of the spiralock system load allows that the pin has an outstanding performance against torque loss. The S region (FIG. 20) can be greater than the T region (FIG. 22), which ensures a greater outflow in the quick coupling. The load loss can be smaller because the pin thread (75) can be less than the conventional thanks to the spiralock system. It gives a bigger region for S than for T because the thread occupies less space in a critical outflow point.

1. An improved hydraulic coupling for quick coupling of an A and B series ISO 7241-1 type, comprising a bigger contact surface because the balls that are fixed to the plug coupling groove have a reduced diameter that allows a greater number of balls, without reducing the material section between the holes that host the balls.

2. An improved hydraulic coupling for quick coupling according to claim 1, wherein socket coupling balls in the plug coupling have the following relation of nominal size and ball diameter:

| Nominal size | ISO standard | Ball Ø |
|---|---|---|
| 6.3 | 7241-1 series A | 3.00 |
| 10 | 7241-1 series A | 3.00 |
| 12.5 | 7241-1 series A | 3.97 |
| 20 | 7241-1 series A | 4.50 |
| 25 | 7241-1 series A | 4.50 |
| 31.5 | 7241-1 series A | 4.76 |
| 5 | 7241-1 series B | 2.50 |
| 6.3 | 7241-1 series B | 2.50 |
| 10 | 7241-1 series B | 3.97 |
| 12.5 | 7241-1 series B | 3.50 |
| 20 | 7241-1 series B | 4.76 |
| 25 | 7241-1 series B | 5.55 |

3. An improved hydraulic coupling for quick coupling according to claim 1, comprising a plug coupling with a peripheral duct geometry to support the socket coupling connector balls formed by an inclined wall with an angle of approximately 27°, a short horizontal flat wall, and an opposite inclined wall.

4. An improved hydraulic coupling for quick coupling of an ISO 16028 face-flat type configured to employ an unique internal in both a plug coupling and socket, not having an isolated area of the pressurized hydraulic system, and having an equalizer for the plug coupling and an equalized for the socket coupling, wherein they are moved by the area equalization system and balance of forces, whereas the only force to be overcome is the spring force.

5. An improved hydraulic coupling for quick coupling according to claim 4, comprising
a coupling body, a pierced central wall where is inserted the central pin, fixed by a thread, which has a prominent and flat head;
the equalized slides inside the coupling body, being sealed by an o'ring;
the equalized is maintained against the central pin head by a spring that positions between the coupling body and an external ring of the; and
a second spring is assembled around the first spring, and is supported on the coupling body and maintains the protection sealed against an internal peripheral prominence existing in the anterior connector face in order to isolate the equalized from the external environment.

6. An improved hydraulic coupling for quick coupling according to claim 4, where in the socket coupling balls in the plug coupling have the following relation of nominal size and ball diameter:

| Nominal size | ISO standard | Ball Ø |
|---|---|---|
| 6.3 | 16028 | 3.00 |
| 10 | 16028 | 3.00 |
| 12.5 | 16028 | 3.50 |
| 16 | 16028 | 3.50 |
| 19 | 16028 | 3.96 |
| 25 | 16028 | 3.96 |

7. An improved hydraulic coupling for quick coupling according to claim 4, comprising a plug quick coupling comprising
one internal equalizer that follows the dimensioning in which the respective area of the ØU must be similar to the ØW area minus the ØK area in addition to an anterior cylindrical part that is threaded in a posterior cylindrical part (82);
the equalizer comprehends a ØU cylindrical body, a closed head, a peripheral flap with holes for external oil throughput into the interior, and a peripheral groove after the head for setting an O-ring;
standard coupling pin has an internal peripheral groove for setting the sealing O-ring against the ØK head, followed by a second internal peripheral groove for setting a special sealing against the head, an external peripheral groove with a breather hole for the air outlet when coupling the couplings;
the coupling body has a peripheral groove for setting a sealing O-ring of the ØU body, an internal buffer to stop the equalizer; and
a chamber located between the equalizer body, the coupling body, and the standard coupling pin, where a spring is placed.

8. An improved hydraulic coupling for quick coupling according to claim 4, comprising a socket quick coupling comprising
an internal equalizer that is different from the others because it has the following characteristic ØQ<ØK with a protection, a connector that is threaded in a body, a ball collar, and a central pin;
the coupling body has a central pierced wall where the central pin is inserted, which is equipped with a prominent and flat head;
the equalized is formed by two cylindrical portions with ØQ, which is less than the ØK and a peripheral ring, whereas the slides inside the body, being the sealed by an O-ring, and maintained pressed against the central pin head by a spring that is placed between the coupling body, and an external ring;
a second spring is assembled around the first spring and is supported on the coupling body, and keeps the protection sealed against an existing peripheral internal prominence on the anterior connector face in order to isolate the equalized from the external environment;
the pin is fixed directly on the pierced wall of the coupling body through a “spiralock” thread; and
the connector has a rabbet that hosts the ball collar spring.
